(19) United States
(12) Patent Application Publication
(10) Pub. No.: US 2023/0096493 A1
(43) Pub. Date: Mar. 30, 2023

(54) Methods and Systems for Trajectory Planning of a Vehicle

(71) Applicant: Aptiv Technologies Limited, St. Michael (BB)

(72) Inventors: Seyed Amin Alamdari Sajadi, Wupperetal (DE); Anand Vijaykumar, Wuppertal (DE)

(21) Appl. No.: 17/936,512

(22) Filed: Sep. 29, 2022

(30) Foreign Application Priority Data
Sep. 29, 2021 (EP) 21199909.9

(51) Int. Cl. B62D 15/02

(52) U.S. Cl. CPC B62D 15/025

(57) ABSTRACT

Disclosed are aspects of systems and computer-implemented methods for trajectory planning of a vehicle. In example embodiments, a method is carried out by computer hardware components and includes determining a reference for a trajectory of the vehicle for a prediction time horizon, with the reference varying over time during the prediction time horizon. The method also includes determining a location error based on the reference for the trajectory and determining a steering command for the vehicle based on the location error.

### INCORPORATION BY REFERENCE

This application claims priority to European Patent Application Number EP21199909.9, filed Sep. 29, 2021, the disclosure of which is incorporated by reference in its entirety.

### BACKGROUND

Autonomously driving vehicles do not only have to observe a safe distance to vehicles and other objects in front of and behind the vehicle, but also to the side. A lateral control method in an autonomous vehicle is intended to track a desired path, and, in case of a lane centering application, the lane center is the desired path. This tracking application should be performed in a safe and comfortable manner.

### SUMMARY

Accordingly, there is a need for efficient and reliable tracking.

The present disclosure relates to methods and systems for trajectory planning of a vehicle.

The present disclosure provides a computer-implemented method, a computer system, a vehicle, and a non-transitory computer-readable medium according to the independent claims. Embodiments are given in the claims, the description, and the drawings.

In one aspect, the present disclosure is directed at a computer-implemented method for trajectory planning of a vehicle, with the method comprising the following steps performed (e.g., carried out) by computer hardware components: determining a reference for a trajectory of the vehicle for a prediction time horizon, with the reference varying over time during the prediction time horizon; determining a location error based on the reference for the trajectory; and determining a steering command for the vehicle based on the location error.

According to an embodiment, the reference is determined based on a tanh-function.

According to an embodiment, the reference is determined based on an initial value of a lateral offset.

According to an embodiment, the reference is determined based on a reference value to be achieved.

According to an embodiment, the reference is determined based on an arc-length state of the vehicle.

According to an embodiment, the arc-length state varies over the prediction time horizon.

According to an embodiment, the arc-length state is determined based on curvature and ego speed. The arc length may be calculated from the vehicle as an origin. The arc length may start with zero (0), and the rest of the state in the horizon may be predicted based on the curvature and the ego speed.

According to an embodiment, the reference is determined based on a velocity (v) of the vehicle.

According to an embodiment, the velocity varies over the prediction time horizon.

According to an embodiment, the velocity is determined using a sensor mounted at the vehicle.

According to an embodiment, the location error is determined using model predictive control.

In another aspect, the present disclosure is directed at a computer system, with the computer system comprising a plurality of computer hardware components configured to carry out several or all steps of the computer-implemented method described herein. The computer system can be part of a vehicle.

The computer system may comprise a plurality of computer hardware components (e.g., a processor, for example a processing unit or processing network; at least one memory, for example a memory unit or memory network; and at least one non-transitory data storage). It will be understood that further computer hardware components may be provided and used for carrying out steps of the computer-implemented method in the computer system. The non-transitory data storage and/or the memory unit may comprise a computer program for instructing the computer to perform several or all steps or aspects of the computer-implemented method described herein, for example using the processing unit and the at least one memory unit.

In another aspect, the present disclosure is directed at a vehicle comprising the computer system as described herein.

According to an embodiment, the vehicle further comprises a sensor configured to determine at least one of a location of the vehicle or a speed of the vehicle.

In another aspect, the present disclosure is directed at a non-transitory computer-readable medium comprising instructions for carrying out several or all steps or aspects of the computer-implemented method described herein. The computer-readable medium may be configured as: an optical medium, such as a compact disc (CD) or a digital versatile disk (DVD); a magnetic medium, such as a hard disk drive (HDD); a solid-state drive (SSD); a read only memory (ROM), such as a flash memory; or the like. Furthermore, the computer-readable medium may be configured as a data storage that is accessible via a data connection, such as an internet connection. The computer-readable medium may, for example, be an online data repository or a cloud storage.

The present disclosure is also directed at a computer program for instructing a computer to perform several or all steps or aspects of the computer-implemented method described herein.

With the methods, devices, and systems as described herein, reference generation for lane centering and lane change, for example for use in an advanced driver assistance system (ADAS), may be provided.

### BRIEF DESCRIPTION OF THE DRAWINGS

Example embodiments and functions of the present disclosure are described herein in conjunction with the following drawings, showing schematically:

FIG. 1 is an illustration of a model predictive controller;

FIG. 2 is a polynomial based trajectory;

FIG. 3 is a comparison of reference generated using polynomial and mimic function;

FIG. 4 is a comparison of reference generated using polynomial and mimic function;

FIG. 5 is a steering response comparison between constant reference in horizon and varying reference;

FIG. 6 is a cross tracking error comparison between constant reference in horizon and varying reference;

FIG. 7 is an orientation error comparison between constant reference in horizon and varying reference;

FIG. 8 is a flow diagram illustrating a method for trajectory planning of a vehicle; and

FIG. 9 is a computer system with a plurality of computer hardware components configured to carry out steps of a computer-implemented method for trajectory planning of a vehicle according to various embodiments.

### DETAILED DESCRIPTION

Side collision warning systems may warn the driver about a side collision with a collidable object, for example another vehicle or a barrier. This may be done by calculating the lateral distance between the collidable object and the host vehicle and estimating the time to collision between the host vehicle and the collidable object. If any of these two variables is below a corresponding threshold, the system may output a side collision warning.

According to various embodiments, a mathematical cost function and a stable system dynamics may be provided in order to design the model predictive controller which minimizes the cost and provides an optimal solution to control the vehicle laterally. The cost function may include a term that minimizes the lateral offset with respect to lane center. With regard to this, a reference value for the lateral offset may be provided. This reference value may be a continuous function that varies within the horizon.

According to various embodiments, devices and methods for vehicle (side) collision prediction utilizing modified functions for the model predictive controller may be provided.

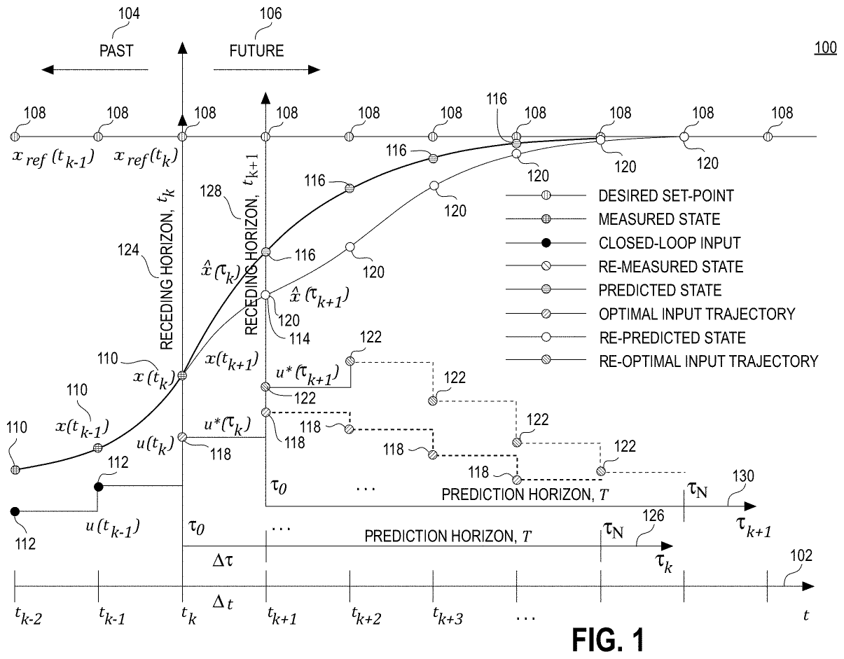

FIG. 1 shows an illustration 100 of a model predictive controller.

Model predictive controller may be a powerful controller. As the name indicates, the controller may predict the state of the vehicle, for example the lateral offset from reference and orientation error with respect to reference of a vehicle for a finite horizon time (T). The reference value for the vehicle may be calculated by a planning block, and then this value is introduced to a Model Predictive Control (MPC), such that it compensates for the error by generating a control signal at the current time instance.

In FIG. 1, a time axis 102 (with past time 104 and future time 106), the desired set-point 108, measured states 110, closed-loop input 112, re-measured state 114, predicted states 116, optimal input trajectory 118, re-predicted state 120, and re-optimal input trajectory 122 are illustrated. A receding horizon (tₖ) 124 and a corresponding prediction horizon (T) 126 are shown. A receding horizon (tₖ₊₁) 128 and a corresponding prediction horizon (T) 130 are shown.

The following symbols may be used:
tₖ—current time step;
t—time axis forward in time;
T— prediction horizon (duration of prediction of states);
Δt—sampling period;
u*(τₖ)—optimal control value at the current time step;
x_{ref}(tₖ)—reference trajectory for states; and
\hat{x}(T)—predicted states.

The cost function according to various embodiments may be used by the optimizer in the model predictive controller to provide the optimal control value at the current time step. In this case, the steering angle may be the optimal control signal sequence (u*) that is used to actuate the vehicle in order to minimize error of orientation and lateral offset (states of the system). Based on the system dynamics and the cost functions designed, the predictions of trajectory may also be calculated. The obtained control sequence may be the motion control sequence that can be applied to the vehicle.

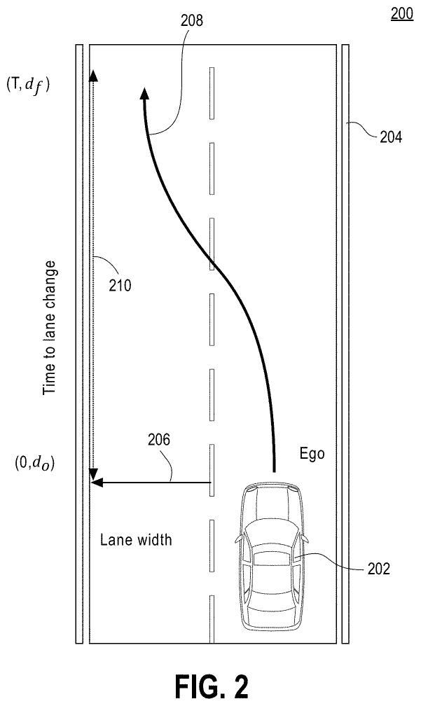

FIG. 2 shows an illustration of a vehicle 202 (which may be referred to as ego vehicle) on a road 204 with lane width 206. A trajectory 208 and a time to lane change 210 are illustrated.

Various trajectory planners may generate a polynomial based trajectory to merge to the reference. This reference may be the lane center for a typical lane centering method or a lane change for an automatic lane change application. The error in the position of the vehicle may be provided to a motion controller which generates a steering command to compensate for the error. The equation (1) below represents an example equation for reference generation:

d_{ref}=a₀+a₁dt+a₂dt²+a₃dt³+a₄dt⁴+a₅dt⁵ (1)

The path generated in this example is a 5th order polynomial which is solved using a two point boundary value problem by optimizing the jerk for comfort of passengers. The values a₀, a₁, a₂, a₃, a₄, a₅ may represent the coefficients of the polynomial, dt may represent the sampling time during the maneuver of the vehicle, and d_{ref} may represent the value of the generated reference at that time instant that needs to be tracked by the motion controller.

Various approaches may generate a reference and a single reference value may be constant throughout the length of the prediction horizon (T) in the current time step. In the next planning interval, a new reference value based on the position of the vehicle may be generated and again kept constant in the entire length of the prediction horizon (T) and this process may repeat until the vehicle has completely aligned with the desired reference.

According to various embodiments, two strategies are provided to address the above-mentioned problem using MPC in a different way. This technique creates a smoother approach to the reference by the vehicle as will be shown in various Figures that are described below.

A 5th order polynomial approximate function as the polynomial based trajectory may suffer from overhead of calculations as it uses power of variables and also an overfitting problem that needs to be dealt with.

According to various embodiments, a different function which generates very similar profile as that of the polynomial provides a good approach as this reduces complexity of calculations. The function according to various embodiments (for example as described in equation (2) below) matches the polynomial in all cases for different initial and final conditions of the vehicle.

As described above, various approaches generate a reference value to be achieved and keep this constant throughout the horizon. In contrast, according to various embodiments, the reference generation function within the horizon which varies across the length of the horizon depending on the position and speed of the vehicle may be introduced. This may improve stability and may merge into the desired reference more smoothly as this considers the position and velocity of the vehicle at every point in the horizon.

An example of an approximate function that mimics the polynomial is given by:

$${d}_{ref} = {b}_{0} + 0.5 * ( d - {b}_{0} ) * ( 1 + tanh \frac{\frac{4.5}{T} * ( s - ( \frac{T}{2} ) * v )}{( 1 + v )} ) , \qquad ( 2 )$$

in which the variables may be described as follows.

The variable b₀ may represent an initial value of the lateral offset from lane center which is obtained from a suitable vehicle sensor input.

The variable d may represent a reference value that needs to be achieved. This may be similar to the final boundary condition of the lateral position of the vehicle in the polynomial approach. This may be the lateral offset from the lane center for lane centering, the lateral offset from a target new lane center for lane changing, or a bias value within the lane for a lane biasing maneuver.

The variable s may represent the arc-length state of the vehicle. This state may correspond to the entire predicted value of the position of the vehicle longitudinally in the Frenet coordinate and hence the name is s instead of x.

In order to imitate a human like driving experience, the trajectory generation problem formulation may be achieved in Frenet coordinates. The Frenet coordinates may also be referred to as road coordinates, and they may be modeled with two main states, e.g., a timed offset from the lane center denoted by d (t) and a covered arc length of the vehicle along the lane center denoted as s(t). The measurements from the vision systems in the current vehicle set up may already be in road coordinates and hence may make for an effective way of controlling the vehicle. Generally, industrial vision systems may provide measurements in road coordinates which may make design easier with minimum coordinate transformations.

The variable v may represent the velocity state of the vehicle. This may contain a value starting from the initial velocity of the vehicle and the predicted velocity until the end of the horizon.

The variable T may represent the time to lane change which may be a self-tuning parameter based on speed of the vehicle.

As will be understood from the above equation, the reference value d_{ref} varies across the entire horizon based on the predicted values of s and v, which is different from various other approaches where the reference is a constant value.

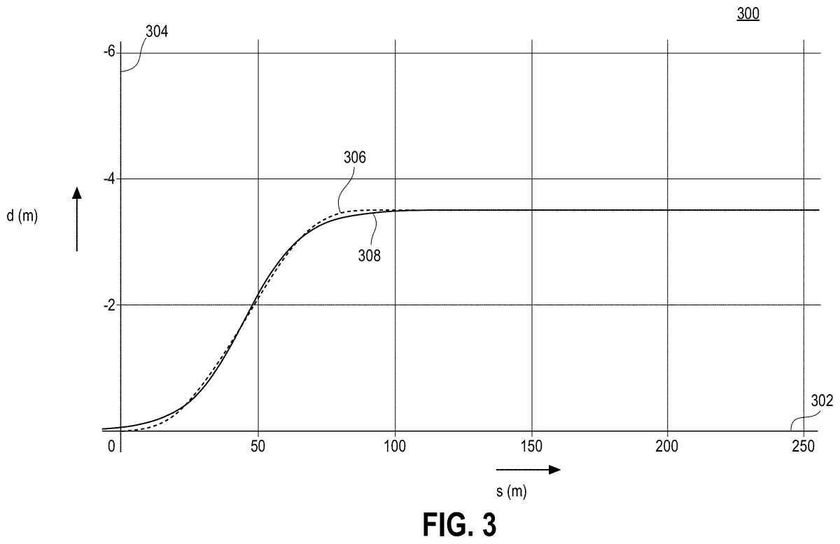

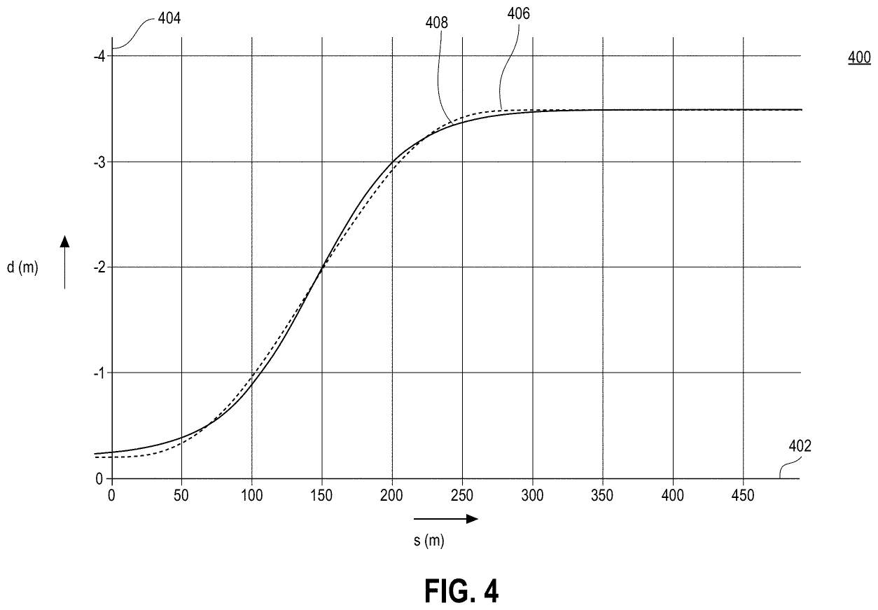

Plots of two different cases are shown in FIG. 3 and FIG. 4. The plots show the difference between a polynomial function and the approximated function according to equation (2) used to achieve the same goal.

FIG. 3 shows an illustration 300 with a horizontal axis 302 representing a forward direction of the vehicle and a vertical axis 304 representing a lateral position of the vehicle. Curve 306 represents the polynomial function, and the curve 308 represents the approximate function according to equation 2.

The graph of FIG. 3 has been plotted for a use case with the following example parameters:

b₀=0.0 meters (m);
d=3.5 m (a similar reference value may be desired for a lane change, assuming that the lane width in this case is 3.5 m);
s=0 m initial value (and this can grow over time based on the speed of vehicle);
v=20 meters-per-second (m/s); and
T=5 seconds (s).

A different plot may be generated if any of the initial conditions or parameters such as the time to lane change varies from the above-mentioned example. To compare another use case, if the time to lane change T=8 s, speed v=36 m/s, and an initial lateral offset from lane center b₀=0.2 m, the plots of FIG. 4 may be obtained.

FIG. 4 shows an illustration 400 with a horizontal axis 402 representing a forward direction of the vehicle and a vertical axis 404 representing a lateral position of the vehicle. Curve 406 represents the polynomial function, and the curve 408 represents the approximate function according to equation 2.

In the following, graphs and plots showing the change in lateral offset from current position to the final reference value will be described. It may be seen that the steering response and also the change in lateral offset of the vehicle is much smoother for the reference generation function according to various embodiments (for example according to equation (2)) with the horizon as compared to a final constant target reference value. The use case for the plots below is to have a lane change like behavior where the required lateral offset from an initial offset is approximately the lane width (3.5 m in this case).

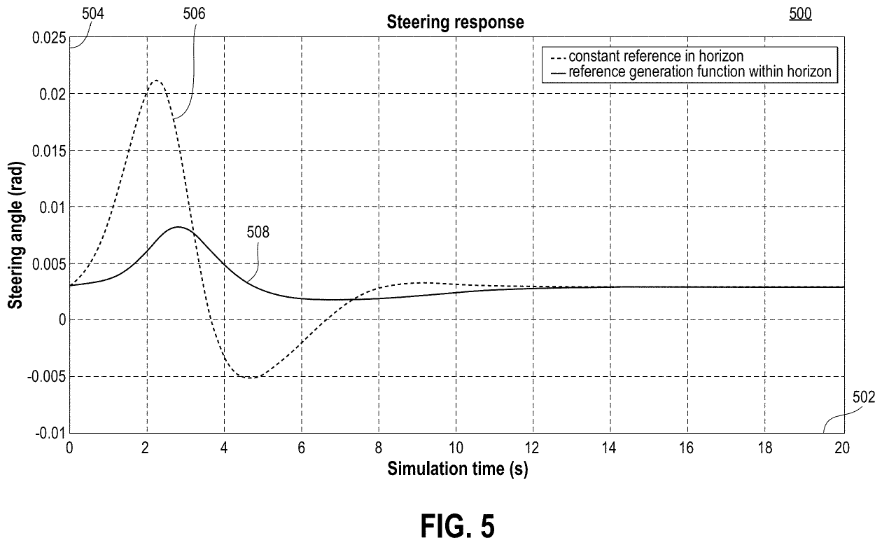

FIG. 5 shows an illustration 500 of a steering response that has a much smoother rise and a significantly lower amplitude for the same maneuver. This in practical test would result in a comfortable lane change for the passenger. A horizontal axis 502 indicates time, and a vertical axis 304 indicates the steering angle. Curve 506 results from a constant reference in horizon. Curve 508 results from a reference generation function within the horizon, for example according to equation (2).

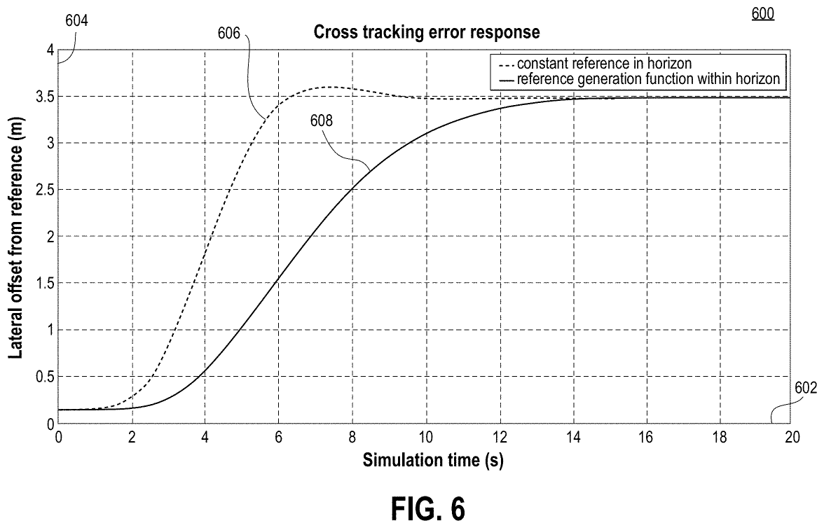

FIG. 6 shows an illustration 600 of the comparison between the lateral offset for both cases and that the modified cost makes the rate of lateral offset smaller than the conventional, again resulting in a smoother maneuver. Also, a difference may be noted in the overshoots between the plots suggesting that the varying reference function in the horizon has a smaller overshoot for the same maneuver as compared to the constant reference value. A horizontal axis 602 indicates time, and a vertical axis 604 indicates the lateral offset. Curve 606 results from a constant reference in horizon. Curve 608 results from a reference generation function within horizon, for example according to equation (2).

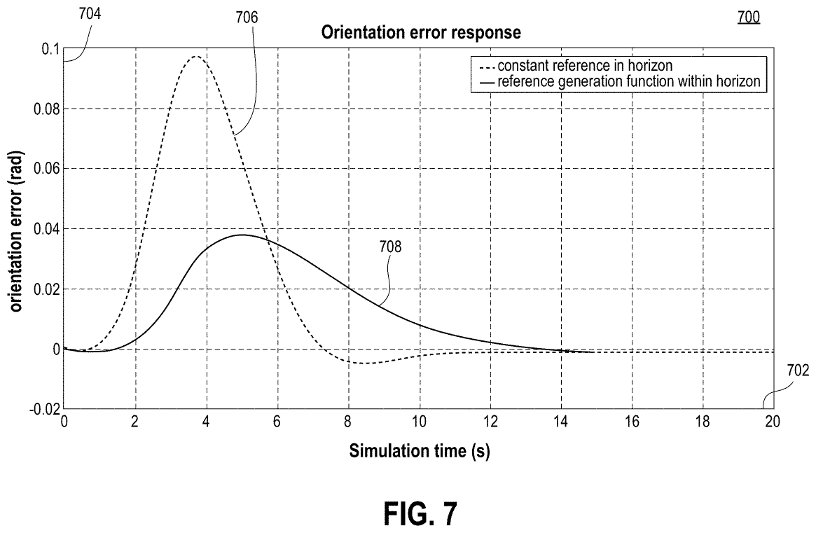

FIG. 7 shows an illustration 700 of the difference in orientation errors. This may have a significant difference where the compensation of the error with the varying reference is far better than the constant reference value. A horizontal axis 702 indicates time, and a vertical axis 704 indicates the orientation error. Curve 706 results from a constant reference in horizon. Curve 708 results from a reference generation function within horizon, for example according to equation (2).

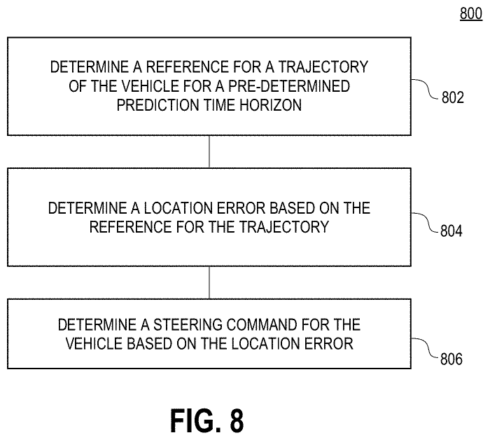

FIG. 8 shows a flow diagram 800 illustrating a method for trajectory planning of a vehicle. At 802, a reference for a trajectory of the vehicle for a pre-determined prediction time horizon may be determined, wherein the reference varies over time during the prediction time horizon. At 804, a location error may be determined based on the reference for the trajectory. At 806, a steering command may be determined for the vehicle based on the location error.

According to various embodiments, the reference may be determined based on a tanh-function.

According to various embodiments, the reference may be determined based on an initial value (b0) of a lateral offset.

According to various embodiments, the reference d_{ref} may be determined based on a reference value (d) to be achieved.

According to various embodiments, the reference may be determined based on an arc-length state (s) of the vehicle.

According to various embodiments, the arc-length state (s) may vary over the prediction time horizon.

According to various embodiments, the arc-length state (s) may be determined based on curvature and ego speed.

According to various embodiments, the reference may be determined based on a velocity (v) of the vehicle.

According to various embodiments, the velocity (v) may vary over the prediction time horizon.

According to various embodiments, the velocity (v) may be determined using a sensor mounted at the vehicle.

According to various embodiments, the location error may be determined using model predictive control.

Each of the steps 802, 804, 806, and the further steps described above may be performed by computer hardware components.

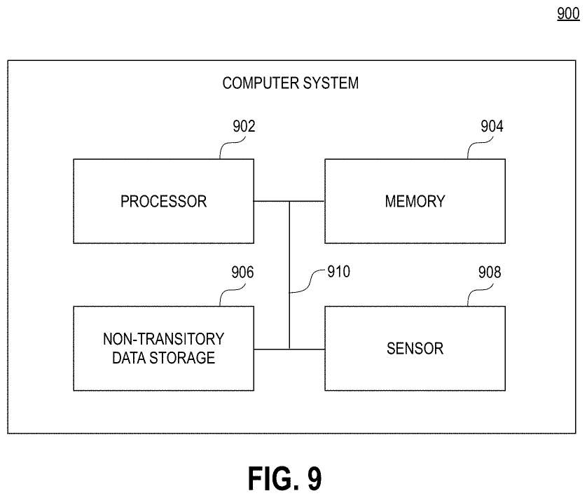

FIG. 9 shows a computer system 900 with a plurality of computer hardware components configured to carry out steps of a computer-implemented method for trajectory planning of a vehicle according to various embodiments. The computer system 900 may include a processor 902, a memory 904, and a non-transitory data storage 906. A sensor 908 may be provided as part of the computer system 900 (like illustrated in FIG. 9), or it may be provided external to the computer system 900.

The processor 902 may carry out instructions provided in the memory 904. The non-transitory data storage 906 may store a computer program, including the instructions that may be transferred to the memory 904 and then executed by the processor 902. The sensor 908 may be used for determining at least one of a location of the vehicle or a speed of the vehicle.

The processor 902, the memory 904, and the non-transitory data storage 906 may be coupled with each other, e.g. via an electrical connection 910, such as e.g. a cable or a computer bus or via any other suitable electrical connection to exchange electrical signals. The sensor 908 may be coupled to the computer system 900, for example via an external interface, or may be provided as parts of the computer system (in other words: internal to the computer system, for example coupled via the electrical connection 910).

The terms “coupling” or “connection” are intended to include a direct “coupling” (for example via a physical link) or direct “connection” as well as an indirect “coupling” or indirect “connection” (for example via a logical link), respectively.

It will be understood that what has been described for one of the methods above may analogously hold true for the computer system 900.

### EXAMPLE IMPLEMENTATIONS

Example 1: Computer-implemented method for trajectory planning of a vehicle, the method comprising the following steps carried out by computer hardware components: determining a reference for a trajectory of the vehicle for a pre-determined prediction time horizon, wherein the reference varies over time during the prediction time horizon; determining a location error based on the reference for the trajectory; and determining a steering command for the vehicle based on the location error.

Example 2: The computer-implemented method of example 1, wherein the reference is determined based on a tanh-function.

Example 3: The computer-implemented method of at least one of examples 1 to 2, wherein the reference is determined based on an initial value (b0) of a lateral offset.

Example 4: The computer-implemented method of at least one of examples 1 to 3, wherein the reference is determined based on a reference value (d) to be achieved.

Example 5: The computer-implemented method of at least one of examples 1 to 4, wherein the reference is determined based on an arc-length state (s) of the vehicle.

Example 6: The computer-implemented method of example 5, wherein the arc-length state (s) varies over the prediction time horizon.

Example 7: The computer-implemented method of at least one of examples 5 or 6, wherein the arc-length state (s) is determined based on curvature and ego speed.

Example 8: The computer-implemented method of at least one of examples 1 to 7, wherein the reference is determined based on a velocity (v) of the vehicle.

Example 9: The computer-implemented method of example 8, wherein the velocity (v) varies over the prediction time horizon.

Example 10: The computer-implemented method of at least one of examples 8 or 9, wherein the velocity (v) is determined using a sensor mounted at the vehicle.

Example 11: The computer-implemented method of at least one of examples 1 to 10, wherein the location error is determined using model predictive control.

Example 12: Computer system, the computer system comprising a plurality of computer hardware components configured to carry out steps of the computer-implemented method of at least one of examples 1 to 11.

Example 13: A vehicle comprising the computer system of example 12.

Example 14: The vehicle of example 13, further comprising: a sensor configured to determine at least one of a location of the vehicle or a speed of the vehicle.

Example 15: Non-transitory computer-readable medium comprising instructions for carrying out the computer-implemented method of at least one of examples 1 to 11.

### LIST OF REFERENCE CHARACTERS FOR THE ELEMENTS IN THE DRAWINGS

The following is a list of certain items in the drawings, in numerical order. Items not present in the list may nonetheless be part of a given embodiment. For better legibility of the text, a given reference character may be recited near some, but not all, recitations of the referenced item in the text. The same reference number may be used with reference to different examples or different instances of a given item.
100 model predictive controller according to various embodiments
102 time axis
104 past time
106 future time
108 desired set-point
110 measured states
112 closed-loop input
114 re-measured state
116 predicted states
118 optimal input trajectory
120 re-predicted state
122 re-optimal input trajectory
124 receding horizon
126 prediction horizon
128 receding horizon
130 prediction horizon
200 polynomial based trajectory
202 vehicle
204 road
206 lane width
208 trajectory
210 time to lane change
300 illustration of a comparison of reference generated using polynomial and mimic function
302 horizontal axis
304 vertical axis
306 curve
308 curve
400 illustration of a comparison of reference generated using polynomial and mimic function
402 horizontal axis
404 vertical axis
406 curve
408 curve
500 illustration of a steering response comparison between constant reference in horizon and varying reference
502 horizontal axis
504 vertical axis
506 curve
508 curve
600 illustration of a cross tracking error comparison between constant reference in horizon and varying reference
602 horizontal axis
604 vertical axis
606 curve
608 curve
700 illustration of an orientation error comparison between constant reference in horizon and varying reference
702 horizontal axis
704 vertical axis
706 curve
708 curve
800 flow diagram illustrating a method for trajectory planning of a vehicle
802 step of determining a reference for a trajectory of the vehicle for a pre-determined prediction time horizon, wherein the reference varies over time during the prediction time horizon
804 step of determining a location error based on the reference for the trajectory
806 step of determining a steering command for the vehicle based on the location error
900 computer system according to various embodiments
902 processor
904 memory
906 non-transitory data storage
908 sensor
910 connection

What is claimed is:

1. A computer-implemented method for trajectory planning of a vehicle, comprising:
determining a reference for a trajectory of the vehicle for a prediction time horizon, the reference varying over time during the prediction time horizon;
determining a location error based on the reference for the trajectory; and
determining a steering command for the vehicle based on the location error.

2. The computer-implemented method of claim 1, further comprising:
determining the reference for the trajectory based on a tanh-function.

3. The computer-implemented method of claim 1, further comprising:
determining the reference for the trajectory based on an initial value of a lateral offset.

4. The computer-implemented method of claim 1, further comprising:
determining the reference for the trajectory based on a reference value to be achieved.

5. The computer-implemented method of claim 1, further comprising:
determining the reference for the trajectory based on an arc-length state of the vehicle.

6. The computer-implemented method of claim 5, wherein the arc-length state of the vehicle varies over the prediction time horizon.

7. The computer-implemented method of claim 5, further comprising:
determining the arc-length state of the vehicle based on curvature and ego speed.

8. The computer-implemented method of claim 1, further comprising:
determining the reference for the trajectory based on a velocity of the vehicle.

9. The computer-implemented method of claim 8, wherein the velocity of the vehicle varies over the prediction time horizon.

10. The computer-implemented method of claim 8, further comprising:
determining the velocity of the vehicle using a sensor mounted at the vehicle.

11. The computer-implemented method of claim 1, further comprising:
determining the location error using model predictive control.

12. A computer system comprising:
a plurality of computer hardware components configured to:
determine a reference for a trajectory of a vehicle for a prediction time horizon, the reference varying over time during the prediction time horizon;
determine a location error based on the reference for the trajectory; and
determine a steering command for the vehicle based on the location error.

13. The computer system of claim 12, wherein the plurality of computer hardware components is further configured to:
determine the reference for the trajectory based on a tanh-function and an initial value of a lateral offset.

14. The computer system of claim 12, wherein the plurality of computer hardware components is further configured to:
determine the reference for the trajectory based on a reference value to be achieved.

15. The computer system of claim 14, wherein the plurality of computer hardware components is further configured to:
determine the reference for the trajectory based on a velocity of the vehicle, the velocity varying over the prediction time horizon.

16. The computer system of claim 12, wherein the plurality of computer hardware components is further configured to:
determine the reference for the trajectory based on a timed offset from a lane center.

17. The computer system of claim 12, wherein the plurality of computer hardware components is further configured to:
determine the reference for the trajectory based on an arc-length state of the vehicle.

18. The computer system of claim 17, wherein the arc-length state of the vehicle varies over the prediction time horizon.

19. A vehicle comprising a computer system, the computer system comprising:
a plurality of computer hardware components configured to:
determine a reference for a trajectory of the vehicle for a prediction time horizon, the reference varying over time during the prediction time horizon;
determine a location error based on the reference for the trajectory; and
determine a steering command for the vehicle based on the location error.

20. The vehicle of claim 19, further comprising:
a sensor configured to determine at least one of a location of the vehicle or a speed of the vehicle.
